(19) United States
(12) Patent Application Publication
(10) Pub. No.: US 2012/0247866 A1
(43) Pub. Date: Oct. 4, 2012

(54) Acoustic Noise Reducing

(76) Inventor: Antonio M. Lage, Ashland, MA (US)

(21) Appl. No.: 13/077,388

(22) Filed: Mar. 31, 2011

(51) Int. Cl. G10K 11/22

(52) U.S. Cl. 181/196

(57) ABSTRACT

A structure for attenuating noise in an acoustic port or an acoustic waveguide. A tube shaped acoustic passage has an acoustically resistive section near the inlet end or the outlet end. The tube shaped acoustic passage may have an elongated opening covered by acoustically resistive material.

### BACKGROUND

This specification relates to reducing noise in acoustic waveguides and acoustic ports.

### SUMMARY

In one aspect of the specification, an acoustic structure includes a tube shaped acoustic passage having an inlet end for receiving acoustic energy from the acoustic driver and an outlet end for radiating acoustic energy from the acoustic driver to the environment. The tube shaped acoustic passage includes an acoustically resistive section adjacent at least one of the inlet end or the outlet end. The acoustically resistive section may include an opening in the tube shaped acoustic passage and acoustically resistive material positioned in the opening. The tube shaped acoustic structure and the acoustic driver may be positioned in an enclosure. The tube shapes acoustic structure may be acoustically coupled to the acoustic driver by air the enclosure. The tube shaped acoustic structure may be directly acoustically coupled to the acoustic driver. The acoustically resistive section may include an acoustically resistive mesh or screen configured to extend the tube shaped acoustic structure. The acoustic structure may include an acoustically resistive section adjacent the inlet end and the outlet end.

In another aspect, In another aspect of the specification, an acoustic structure, includes a tube shaped acoustic passage having an inlet end for receiving acoustic energy from the acoustic driver and an outlet end for radiating acoustic energy from the acoustic driver to the environment and an elongated opening with a length that is at least five times a width. The direction of elongation may be parallel to a direction of elongation of the tube shaped acoustic passage. An acoustically resistive material may cover the elongated opening. The tube shaped acoustic passage is mounted in an enclosure so that the elongated opening vents from the interior of the tube shaped passage to the interior of the enclosure. The acoustically resistive material may be a wire screen. The elongated opening may run substantially the entire length of the tube shaped acoustic passage. The length of the elongated opening may be at least ten times the width.

Other features, objects, and advantages will become apparent from the following detailed description, when read in connection with the following drawing, in which:

### BRIEF DESCRIPTION OF THE SEVERAL VIEWS OF THE DRAWING

FIGS. 1A and 1B are simplified diagrammatic views of bass loudspeaker systems;

FIG. 2 is a frequency response curve;

FIG. 3 is a mechanical diagram of a spring and mass system for illustrating the operation of the bass loudspeaker system of FIG. 1A;

FIG. 4 is a simplified cross sectional view of a bass loudspeaker for illustrating the operation of the bass loudspeaker of FIG. 1B;

FIG. 5 is a prior art cross sectional view of an open duct port;

FIG. 6 is a diagrammatic view of a prior art loudspeaker with a port tube;

FIGS. 7-9 are oblique views of tube shaped acoustic passages with noise reducing elements;

FIGS. 10A-10C are oblique views of a tube shaped acoustic passage with a noise reducing element;

FIGS. 11A-11D are diagrammatic side partially cross sectional partially plan views of loudspeaker systems; and

FIG. 12 is a frequency response curve.

### DETAILED DESCRIPTION

Though the elements of several views of the drawing may be shown and described as discrete elements in a block diagram and may be referred to as “circuitry”, unless otherwise indicated, the elements may be implemented as one of, or a combination of, analog circuitry, digital circuitry, or one or more microprocessors executing software instructions. The software instructions may include digital signal processing (DSP) instructions. Operations may be performed by analog circuitry or by a microprocessor executing software that performs the mathematical or logical equivalent to the analog operation. Unless otherwise indicated, signal lines may be implemented as discrete analog or digital signal lines, as a single discrete digital signal line with appropriate signal processing to process separate streams of audio signals, or as elements of a wireless communication system. Some of the processes may be described in block diagrams. The activities that are performed in each block may be performed by one element or by a plurality of elements, and may be separated in time. The elements that perform the activities of a block may be physically separated. Unless otherwise indicated, audio signals or video signals or both may be encoded and transmitted in either digital or analog form; conventional digital-to-analog or analog-to-digital converters may not be shown in the figures.

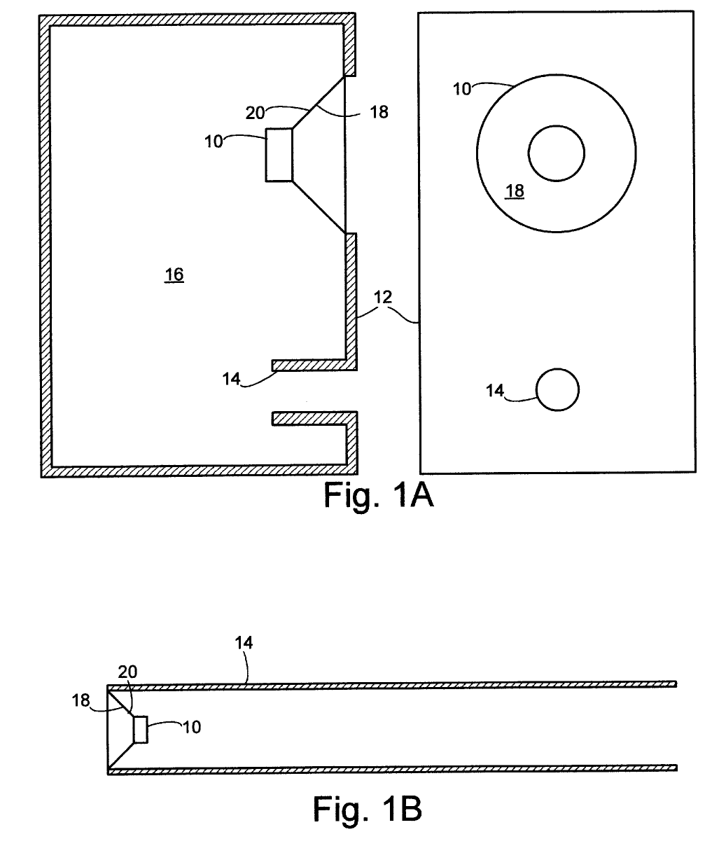

FIG. 1A shows a simplified view of a first bass loudspeaker system. An acoustic driver 10 is mounted in an opening in an enclosure 12. A tube shaped acoustic passage 14 couples the interior of the enclosure with the environment. In operation, a front surface 18 of the acoustic driver diaphragm radiates acoustic energy directly to the environment. A back surface 20 of the acoustic driver diaphragm radiates acoustic energy to the environment through the tube shaped acoustic passage and the interior of the of the enclosure.

FIG. 1B shows a simplified view of a second bass loudspeaker system. An acoustic driver 10 is mounted in an end of a tube shaped acoustic passage 14 so that one surface 18 of the acoustic driver radiates acoustic energy directly to the environment. A back surface 20 of the acoustic driver is directly coupled acoustically to the tube shaped acoustic passage 14 and radiates acoustic energy through the tube shaped acoustic passage to the environment.

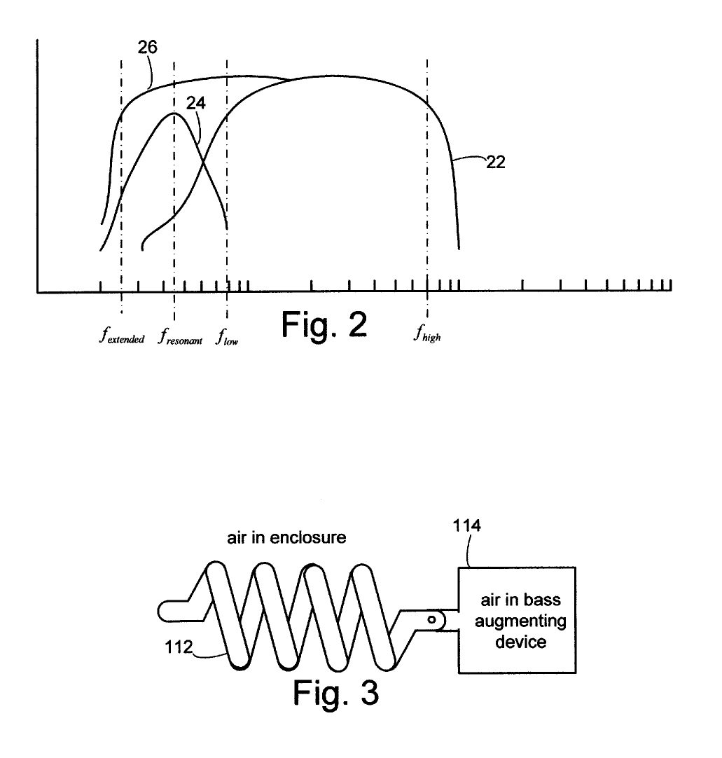

FIG. 2 shows the frequency response of a loudspeaker system such as the loudspeaker systems of FIGS. 1A and 1B. The frequency response curve 22 of the acoustic energy radiated directly to the environment has roll off frequencies at an upper frequency f_{high} and at lower frequency f_{low}. The upper frequency is not highly significant to a bass loudspeaker system because the higher frequencies can be radiated by a mid-range speaker and/or by a tweeter, not shown in this view.

The enclosure 12 and the tube shaped acoustic passage 14 of FIG. 1A or the tube shaped acoustic passage 14 of FIG. 1B can be dimensioned so that the acoustic energy radiated from the tube shaped acoustic passage 14 has a frequency response 24 that, combined with the frequency response 22 of the acoustic energy radiated directly to the environment results in a combined frequency response 26 that has a lower roll off frequency f_{extended} that is lower than the roll off frequency f_{low} of the acoustic energy radiated directly to the environment. The frequency response 24 of the tube shaped acoustic passage 14 has a maximum amplitude at a resonant frequency fᵣₑₛₒₙₐₙₜ.

The resonant frequency of the configuration of FIG. 1A is illustrated in FIG. 3. The elasticity of the air in the enclosure 12 and the mass of the air in the tube shaped acoustic passage act as a spring 112 and mass 114 system with a resonance frequency of

$${f}_{port} = \frac{c}{2 π} \sqrt{\frac{A}{Vl}} ,$$

where c is the speed of sound in air, A is the cross-sectional area of the tube shaped acoustic passage 14, l is the length of the tube shaped acoustic passage, and V is the volume of the enclosure 12. The “port” terminology will be discussed below.

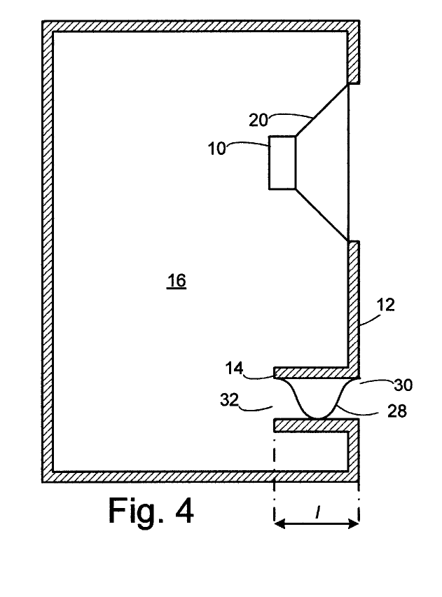

The resonant frequency of the configuration of FIG. 1B is illustrated in FIG. 4. At the open end 30 of the waveguide and the interior end 32 there are impedance mismatches between the tube shaped acoustic passage and the environment and the interior of the enclosure, respectively, so that some energy is reflected. The reflected energy results in a standing wave 28 in the tube shaped acoustic passage. A first, and most prominent, standing wave occurs at a frequency

$${f}_{waveguide} = \frac{c}{4 l} ,$$

where c is the speed of sound in air and l is the effective length of the tube shaped acoustic passage. The “effective length” of the tube shaped acoustic passage is equal to the physical length of the tube shaped acoustic passage plus end effects. “End effect” may be estimated by modeling or may be determined empirically. For simplicity, in FIG. 4, l is shown as equal to the physical length. Additional standing waves occur at odd multiples of f_{waveguide}. The “waveguide” subscript will be discussed below.

Some configurations may have both a frequency f_{waveguide} and the frequency fₚₒᵣₜ. In those cases, a f_{waveguide} and the frequency fₚₒᵣₜ are usually very different, so that typically only one of f_{waveguide} or fₚₒᵣₜ is in the operating range of the bass loudspeaker. If f_{waveguide} is in the operating range of the bass loudspeaker, the tube shaped acoustic passage is typically referred to as a waveguide and if fₚₒᵣₜ is in the operating range of the bass loudspeaker, the tube shaped acoustic passage is typically referred to as a port.

When in operation, ports and waveguides both involve air moving within the tube shaped acoustic passage. There may be a large volume of air moving, and the volume of air may be moving at high velocities. Additionally the air may not move uniformly within the tube shaped acoustic passage; for example, near the walls of the tube shaped acoustic passage, the air may move more slowly than the air not near the walls. Large volumes of air moving at high velocities in a non-uniform manner may result in turbulence, which results in undesirable noise being radiated from the waveguide.

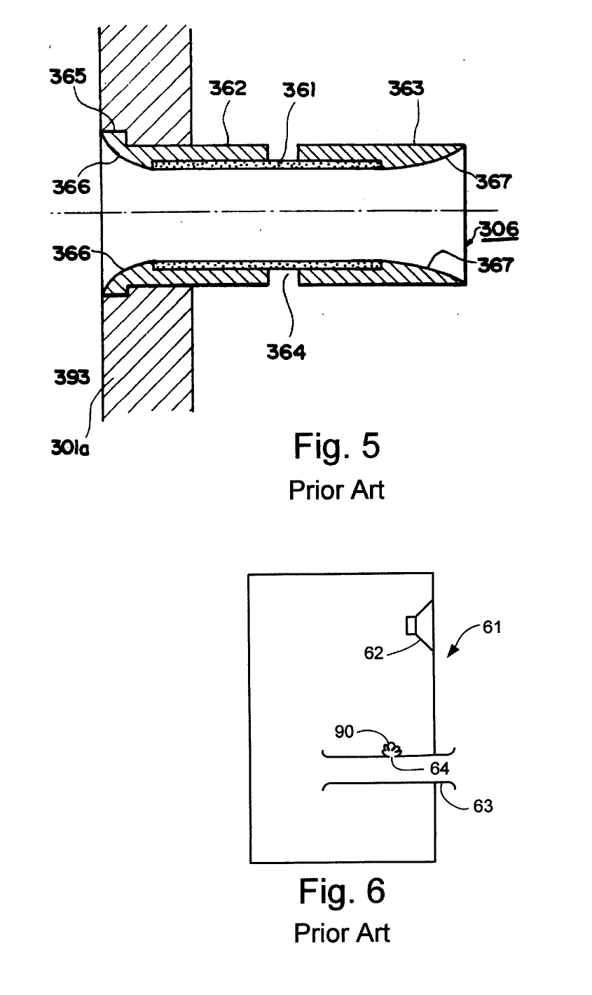

Prior art methods for reducing undesirable noise in tube shaped acoustic passages are illustrated in FIGS. 5 and 6. In the device of FIG. 5 An open duct port 306 comprises an assembly having a structure in which outer cylinders 362 and 363 of rubber (SBR of hardness 50) are fitted around an inner cylinder (core member) 361 of 1-mm thick felt. The open duct port assembly 306 is designed to have an effective port length of about 150 mm and an effective port diameter of about 35 mm as a whole. When this assembly 306 is combined with a cabinet 301 having a volume of 6 liters, the Helmholtz resonance frequency is about 40 Hz. A gap 364 having a width of about 5 mm is formed between the outer cylinders 362 and 363. Thus, at the central portion of the open duct port assembly 306, the felt inner cylinder 361 is exposed from the outer peripheral wall surface of the open duct port in a slit form having a width of about 5 mm along the circumferential direction of the assembly. The outer cylinder 362 extends from the front edge of the inner cylinder 361, and a flange 365 is formed at its distal end. In this acoustic apparatus, the open duct port assembly 306 constituted by the inner cylinder 361 and the outer cylinders 362 and 363 is inserted in a baffle surface 301a of the cabinet 301 from the front surface side, and is aligned such that the flange 365 of the outer cylinder 362 abuts against the baffle surface 301a. The outer cylinder 362 and the baffle surface 301a are fixed by elastic fitting or an adhesive.

In the device of FIG. 6, a loudspeaker enclosure 61 has a driver 62 and a port tube 63 formed with a vent 64 typically located at a point along the length of port tube 63 corresponding to the pressure maximum of the dominant standing wave established in port tube 63 when driver 62 is excited to reduce audible port noise. Acoustic damping material 90, for example polyester or cloth, may be positioned in or near vent 64.

In addition, it may be desirable to establish vents at points other than midway between the ends of the port tubes. For example, consider the wavelength resonance where pressure peaks at a quarter of the tube length from each end.

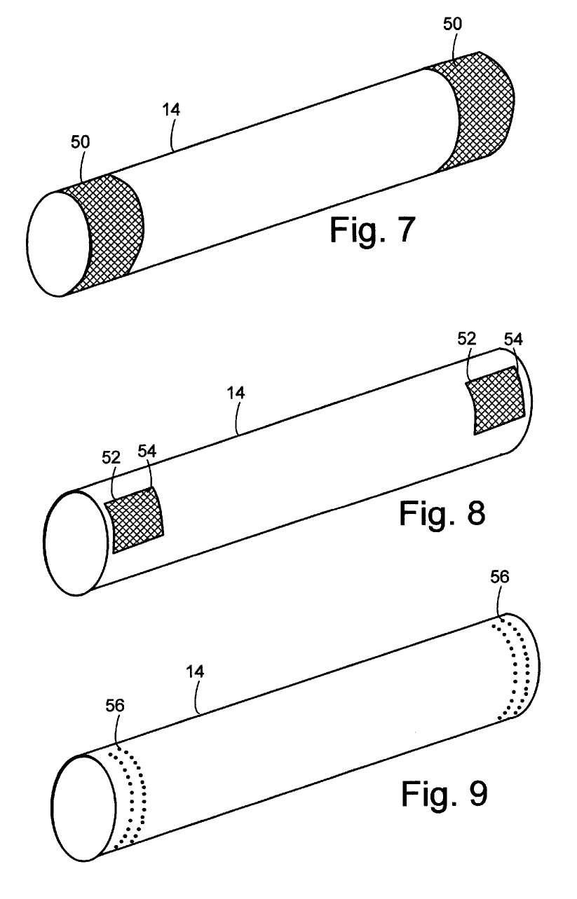

The devices of FIGS. 5 and 6 may be effective at attenuating noise associated with high pressure, such as at the center of the tube or at pressure maxima of harmonics of the frequency corresponding to the dominant standing wave. However, there may be additional noise sources that are not associated with high pressure. For example, there may be turbulence at locations with high airflow at the inlet and the exit. FIG. 7 shows a tube shaped acoustic passage with structure to reduce noise resulting from turbulence at the inlet or exit or both, of a tube shaped acoustic passage. Typically, the tube shapes acoustic passage has a round cross section (so that the tube shaped acoustic passage 14 is a cylinder), but may an oval or some other cross section. A tube shaped acoustic passage 14 has, at the inlet end or the exit end, or both, an acoustically resistive section 50. The acoustically resistive section material may take the form of a mesh or screen that is formed so that the mesh or screen material or some other acoustically resistive material extends the wall of the tube shaped acoustic passage, as shown in FIG. 7.

Alternatively, as in FIG. 8, an opening 52 may be formed in the side of the tube shaped acoustic passage, and mesh or screen material 54 placed so that it covers the opening 52. Alternatively, as in FIG. 9, openings, such as opening 56, of a size sufficient to provide the desired amount of acoustic resistance may be formed in the wall of the tube shaped acoustic passage.

The noise reducing structures of FIGS. 7-9 may be implemented with or without other noise reducing elements, for example as shown in FIGS. 5 and 6.

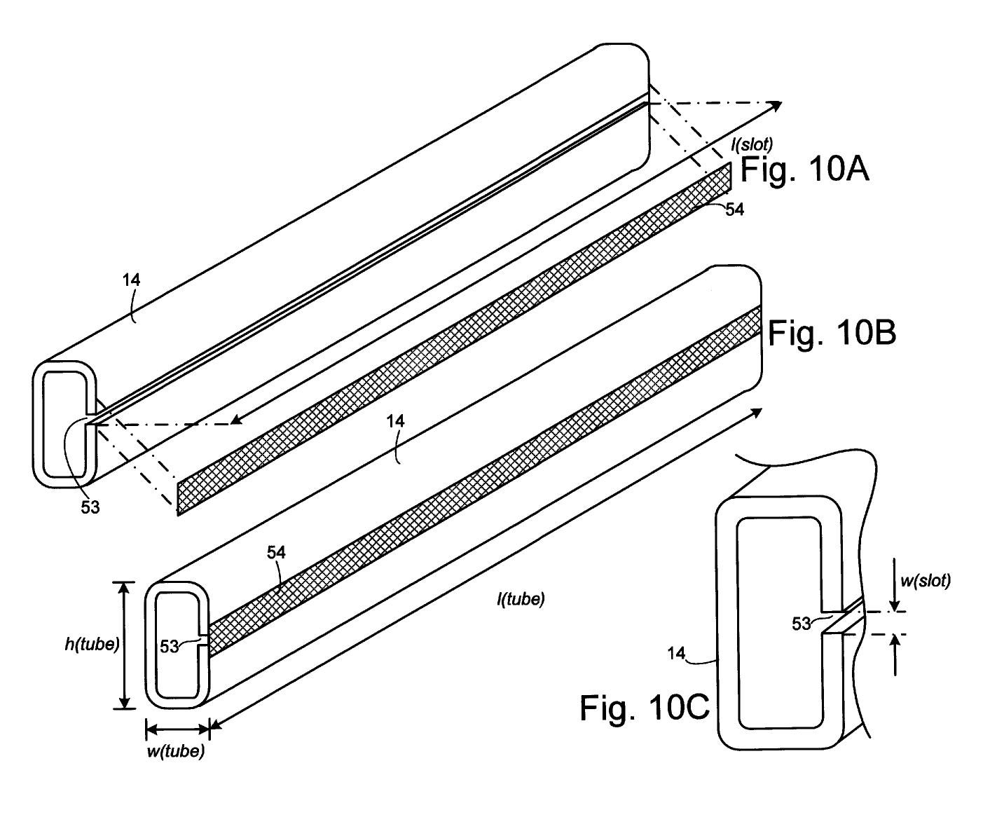

FIGS. 10A-10C show another implementation of a tube shaped acoustic passage with features to reduce noise. There is an elongated slot-shaped opening 53 in the tube shaped acoustic passage 14, that is, an opening that has a length l(slot) that is more than five times the width w(slot) and in some examples more than ten times the width, and may, as in this example have a length l(slot) that is equal to the length l(tube) of the tube, so that a portion of the opening is over the ends and a portion of the opening is over the location of pressure maxima. The elongated slot shaped opening 53 is covered by an acoustically resistive material, in this case wire mesh or screen material 54. For ease of application, the width of the wire mesh may be significantly wider than the width of the slot. FIG. 10A shows that tube shaped acoustic passage 14 and the mesh or screen material 56 in exploded form. FIG. 10B shows the tube shaped acoustic passage and the mesh or screen material in assembled form. FIG. 10C is an enlarged view of the tube shaped acoustic passage 14 and the elongated slot-shaped opening 53.

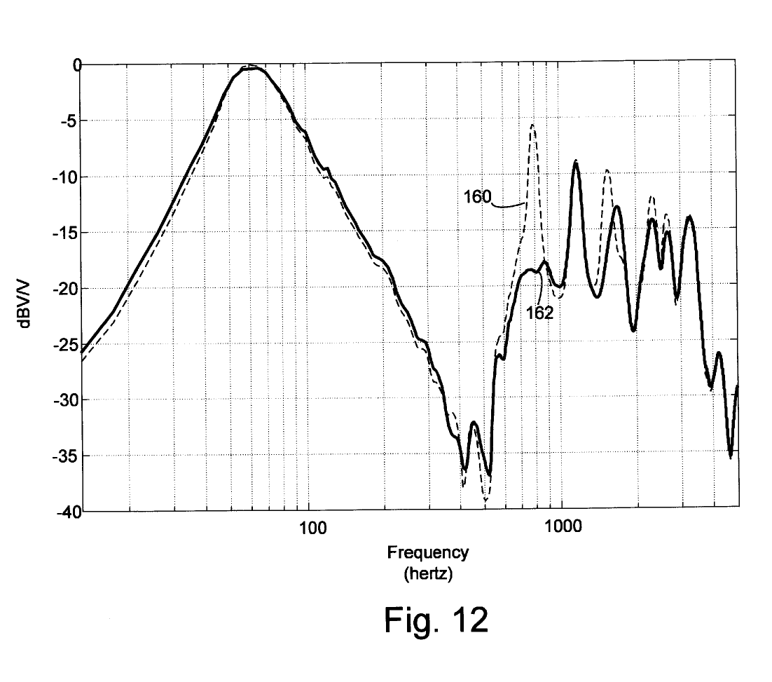

In one implementation, the acoustic passage 14 is substantially rectangular in cross-section, with dimensions as indicated and a port tuning frequency of about 60 Hz. The opening 53 runs the length of the acoustic passage 14 and the width is about 1.02 mm. The wire mesh is Dutch twill weave 65×552 threads per cm. The effect of the opening 53 and the mesh or screen material 54 is shown in FIG. 12. Dashed line 160 represents the frequency response of the acoustic passage 14, with no opening 52. Solid line 162 represents the frequency response of the acoustic passage 14 with the slot opening 52 and the mesh or screen material 54. The resonance peak at about 800 Hz has been significantly reduced.

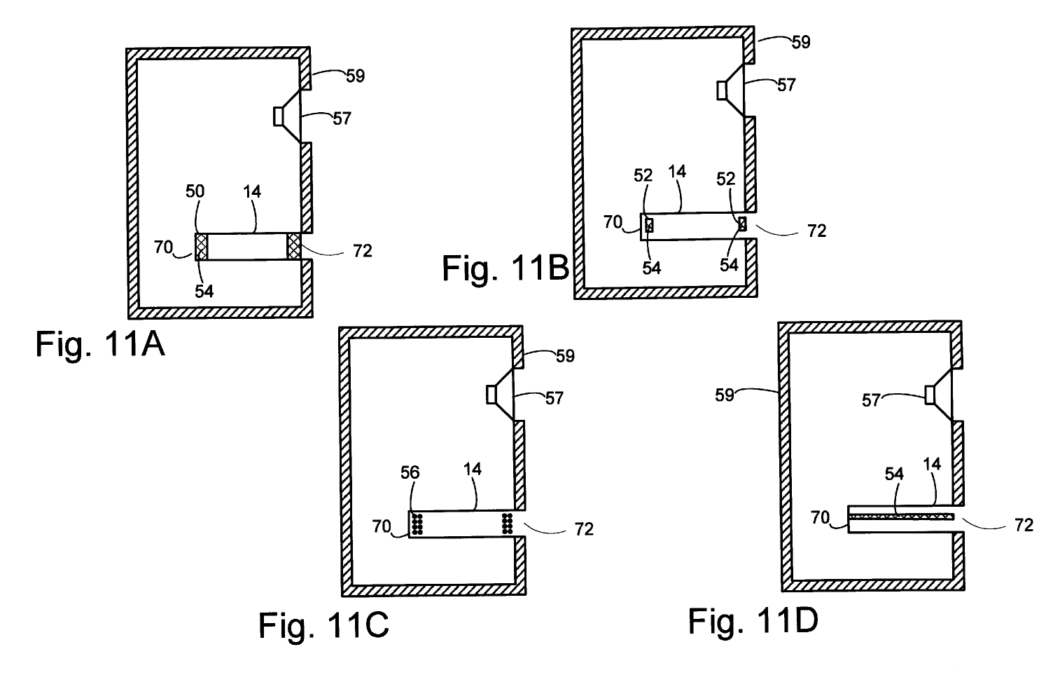

FIG. 1A-11 D show the placement of the tube shaped acoustic passage 14 relative to other components of the loudspeaker of which it is a component. FIGS. 11A-11D all show a loudspeaker that includes an acoustic driver 57 mounted in acoustic enclosure 59 (both the acoustic driver 57 and the acoustic enclosure 59 are shown in cross section). The tube shaped acoustic passage 14 (shown in plan view) is mounted in the interior of the acoustic enclosure 59 so that in inlet end 70 is acoustically coupled to the interior of the enclosure 59 and an outlet end 72 is coupled to the environment. In FIG. 11A, a tube shaped acoustic passage 14 according to FIG. 7 has two acoustically resistive sections 50 that vent from the tube shaped acoustic passage 14 to the interior of the acoustic enclosure 59. In FIG. 11B, a tube shape acoustic passage according to FIG. 9 has an opening 52 the inlet end 70 and at the outlet end 72 are arranged so that the opening vent to the interior of the acoustic enclosure 59. In FIG. 11C, a tube shaped passage 14 according to FIG. 9 has acoustically resistive openings 56 arranged so that they vent from the tube shaped acoustic passage 14 to the interior of the acoustic enclosure. In FIG. 11D, a tube shaped acoustic passage 14 has an elongated slot-shaped opening 53 covered with mesh or screen material 54 according to FIGS. 10A-10C that vent from the tube shaped acoustic passage 14 to the interior of the enclosure 59.

In operation, the acoustic driver radiate acoustic energy to the environment and into the interior of the acoustic enclosure 59. The inlet end 70 receives acoustic energy from the interior of the acoustic enclosure and radiates the acoustic energy through the outlet end 72 to the environment. While the tube shaped acoustic passage is radiating acoustic energy, it may have a port resonance frequency fₚₒᵣₜ or a waveguide resonance frequency f_{waveguide} in the range of operation of the loudspeaker. The acoustically resistive elements (resistive sections 50 of FIG. 7, openings 52 covered with mesh or screen material 54 of FIG. 8, acoustically resistive holes 56 of FIG. 9, or the elongated slot shaped opening 53 covered with mesh or screen material 54) result in reduced noise being radiated from the tube shaped acoustic passage.

Numerous uses of and departures from the specific apparatus and techniques disclosed herein may be made without departing from the inventive concepts. Consequently, the invention is to be construed as embracing each and every novel feature and novel combination of features disclosed herein and limited only by the spirit and scope of the appended claims.

1. An acoustic structure comprising:
an acoustic enclosure having an interior;
a tube shaped acoustic passage having an interior, an inlet end for receiving acoustic energy from an acoustic driver to the passage interior, and an outlet end for radiating the acoustic energy to the environment;
a wall of the tube shaped acoustic passage comprising an acoustically resistive opening adjacent at least one of the inlet end or the outlet end acoustically coupling the interior of the tube shaped acoustic passage with the interior of the acoustic enclosure.

2. The acoustic structure of claim 1, wherein the acoustically resistive an opening in the tube shaped acoustic passage comprises acoustically resistive material positioned in the opening.

3. The acoustic structure of claim 1, wherein the tube shaped acoustic structure and the acoustic driver are positioned in an enclosure, and wherein the tube shaped acoustic structure is acoustically coupled to the acoustic driver by the enclosure.

4. (canceled)

5. (canceled)

6. The acoustic structure of claim 1 comprising an acoustically resistive opening adjacent the inlet end and the outlet end, each opening acoustically coupling the interior of the tube shaped acoustic passage with the interior of the acoustic enclosure .

7. An acoustic structure, comprising:
an acoustic enclosure having an interior;
a tube shaped acoustic passage having an interior, an inlet end for receiving acoustic energy from an acoustic driver to the passage interior, and an outlet end for radiating the acoustic energy to the environment;
an elongated opening with a length that is at least five times a width, with a direction of elongation parallel to a direction of elongation of the tube shaped acoustic passage;
an acoustically resistive material covering the elongated opening;
the tube shaped acoustic passage mounted in an enclosure so that the elongated opening vents from the interior of the tube shaped passage to the interior of the enclosure.

8. The acoustic structure of claim 7, wherein the acoustically resistive material is a wire screen.

9. The acoustic structure of claim 7, wherein the elongated opening runs substantially the entire length of the tube shaped acoustic passage.

10. The acoustic structure of claim 7, wherein the length is at least ten times the width.
